(19) United States
(12) Patent Application Publication
(10) Pub. No.: US 2022/0119610 A1
(43) Pub. Date: Apr. 21, 2022

(54) Preparation Method of Polyurethane-based Nano-silver SERS Substrate

(71) Applicant: Jiangnan University, Wuxi (CN)

(72) Inventors: Guoqing Chen, Wuxi (CN); Lvming Chen, Wuxi (CN); Chun Zhu, Wuxi (CN); Chaoqun Ma, Wuxi (CN); Lei Li, Wuxi (CN); Jiao Gu, Wuxi (CN); Zhuowei Zhu, Wuxi (CN); Hui Gao, Wuxi (CN); Yamin Wu, Wuxi (CN); Zichen Yang, Wuxi (CN); Tuo Zhu, Wuxi (CN)

(21) Appl. No.: 17/564,819

(22) Filed: Dec. 29, 2021

Related U.S. Application Data
(63) Continuation of application No. PCT/CN2020/124249, filed on Oct. 28, 2020.

(30) Foreign Application Priority Data
Oct. 30, 2019 (CN) 2019110459717

(51) Int. Cl. C08J 9/00; C08L 75/04; C08G 18/48; G01N 21/65

(52) U.S. Cl. CPC C08J 9/0071; C08J 9/0061; C08L 75/04; C08G 18/48; B22F 9/24; C08J 2375/04; C08J 2475/08; C08L 2203/14; C08L 2205/025; G01N 21/658

(57) ABSTRACT

The present disclosure herein discloses a preparation method of a polyurethane-based nano-silver SERS substrate, belongs to the technical field of Raman spectrums, and aims to solve problems of complex preparation process, low sensitivity and the like of SERS substrates. The method uses solidified polyurethane as a skeleton, and the polyurethane adsorbs nano silver particles onto its surface due to a porous surface structure and adsorptivity, so an SERS substrate with crystal violet as a probe molecule and having a limit of detection as low as 10⁻¹⁰ M is obtained. The SERS substrate prepared by the method has a large surface area, adsorbs a large number of target molecules, and is easy to prepare, high in sensitivity, and conducive to qualitative and quantitative analysis of SERS.

### TECHNICAL FIELD

The disclosure herein relates to a preparation method of a polyurethane-based nano-silver SERS substrate, and belongs to the technical field of Raman spectrums.

### BACKGROUND

A Raman spectrum is the most commonly used vibrational spectrum for identifying biomolecules. The Raman spectrum can provide valuable information and has great potential in biochemical analysis. In addition, this is a non-destructive testing technique that does not require any pretreatment of food samples. Since the presence of water does not interfere with the analysis of liquid samples, the Raman spectrum is a simple method to identify desired target analyte in a water sample. Surface-enhanced Raman scattering (SERS) is a promising method which has extremely high sensitivity and can even distinguish and detect single molecules. Compared with chemical effects, electromagnetic effects are an important principle for enhancing Raman signals. Due to the excitation of local surface plasmon resonance (LSPR), a large number of local electromagnetic fields excited near a rough surface have a significant impact on the performance of SERS. Metallic materials with nanostructures have a strong SPR effect, biocompatibility, and high chemical and thermal stability, and are considered to be reliable materials for SERS detection. Polymer materials have gradually become important materials for making SERS substrates due to their reliable stability. However, currently disclosed techniques for preparing SERS substrates using polymer materials often have complicated preparation processes. Therefore, it is very necessary to provide an SERS substrate that is simple to prepare and has superior detection performance.

### SUMMARY

The present disclosure herein provides a preparation method of a polyurethane-based nano-silver SERS substrate. The present disclosure herein uses simple and readily available polyurethane as a substrate material, and uses solidified polyurethane as a skeleton, and polyurethane adsorbs nano silver particles onto its surface due to its porous surface property and adsorbability, so the polyurethane-based nano-silver SERS substrate is obtained.

A technical solution of the present disclosure herein is as follows:

A preparation method of a polyurethane-based nano-silver SERS substrate includes the following steps:

(a) reducing silver nitrate with sodium citrate to prepare a nano-silver solution;

(b) mixing and then evenly stirring a polyurethane A glue and a polyurethane B glue, and standing for foaming and solidification; and

(c) chopping foamed and solidified polyurethane into pieces and soaking the pieces in the nano-silver solution to obtain the polyurethane-based nano-silver SERS substrate.

In one implementation, in the step (a), a concentration of a sodium citrate solution is 0.01 g/mL.

In one implementation, in the step (a), a concentration of a silver nitrate solution is 200 mg/L.

In one implementation, in the step (b), a component of the polyurethane A glue is isocyanate, and a component of the polyurethane B glue is composite polyether.

In one implementation, in the step (b), the polyurethane A glue and the polyurethane B glue are mixed at a mass ratio of 1:1.

In one implementation, in the step (b), a foaming and solidification temperature is a room temperature, and foaming and solidification time is 2-6 h.

In one implementation, in the step (c), soaking time of the polyurethane pieces in the nano-silver solution is 6 h or longer.

The beneficial effects of the present disclosure herein:

1. the polyurethane-based nano-silver SERS substrate prepared in the present disclosure herein can provide a porous surface structure for measurement of SERS signals, and adsorb target molecules to be detected;

2. nano silver particles have surface plasmon resonance performance, which can enhance Raman signals;

3. combination of spongy polyurethane and nano-silver makes SERS enhancement superior to using polyurethane or nano silver particles alone, and a limit of detection with crystal violet as a probe molecule is as low as 10⁻¹⁰ M; and

4. the SERS substrate prepared by the method has a large surface area, adsorbs a large number of target molecules, has a simple preparation process, is high in sensitivity, and is conducive to qualitative and quantitative analysis of SERS.

### BRIEF DESCRIPTION OF FIGURES

FIG. 1 is a flow chart of preparing a polyurethane nano-silver SERS substrate.

FIG. 2 is an SERS spectrogram of a polyurethane nano-silver substrate to CV aqueous solutions of different concentrations.

FIG. 3 is a Raman spectrogram of CV aqueous solutions of different concentrations.

FIG. 4 is an SERS spectrogram of polyurethane without nano-silver to CV aqueous solutions of different concentrations.

FIG. 5 is an SERS spectrogram of a nano-silver solution to CV aqueous solutions of different concentrations.

FIG. 6 is an SERS spectrogram of a substrate prepared using PDMS instead of polyurethane to CV aqueous solutions of different concentrations.

### DETAILED DESCRIPTION

A polyurethane A glue and a polyurethane B glue which are used in the present disclosure herein are purchased from Bosheng Technology. A component of the polyurethane A glue is isocyanate, and a component of the polyurethane B glue is composite polyether.

### Example 1

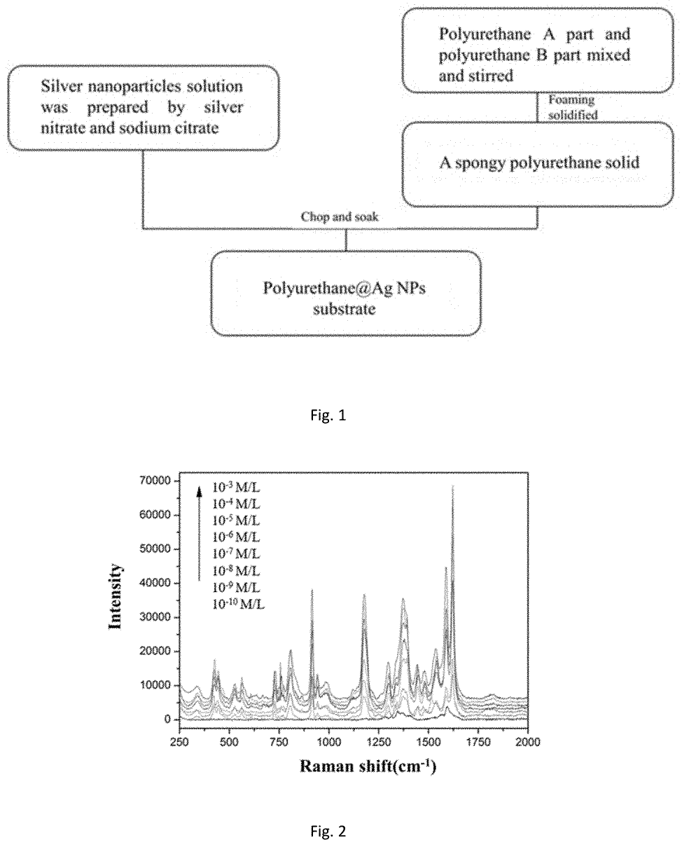

A flow chart of preparing a polyurethane nano-silver SERS substrate according to the present disclosure herein is as shown in FIG. 1.

1. the polyurethane nano-silver SERS substrate is prepared.

(1) silver nitrate is reduced with sodium citrate to prepare a nano-silver solution.

a. a sodium citrate aqueous solution with a concentration of 0.01 g/ml and a silver nitrate aqueous solution with a concentration of 200 mg/L are prepared; and

b. 100 ml of the silver nitrate solution is taken and heated to boil, 3 ml of the sodium citrate solution is quickly dropwise added, stirring is performed while adding, and cooling is performed to a room temperature.

(2) polyurethane is prepared.

a. 5 g of a polyurethane A glue and 5 g of a polyurethane B glue are taken and stirred quickly and intensely; and

b. the polyurethane is subjected to standing at a room temperature for 2-6 h, and is chopped into pieces for later use.

(3) the polyurethane nano-silver SERS substrate is prepared.

a. the chopped polyurethane pieces are soaked in the prepared nano-silver solution, so the polyurethane may adsorb nano silver particles in the solution; and

b. the polyurethane pieces need to be soaked in the nano-silver solution for 6 h or longer.

2. Raman testing is performed on CV aqueous solutions of different concentrations by using the polyurethane nano-silver substrate.

Crystal violet (CV) aqueous solutions with concentrations of 10⁻¹⁰, 10⁻⁹, 10⁻⁸, 10⁻⁷, 10⁻⁶, 10⁻⁵, 10⁻⁴, 10⁻³ and 10⁻² moles per liter are prepared respectively with crystal violet (CV) as a Raman probe. The prepared polyurethane nano-silver substrate is soaked in the crystal violet aqueous solutions for several minutes. After the substrate is taken out, a Raman spectrum is obtained by using an inVia confocal Raman spectrometer. A laser light source is 532 nm, power is 12.5 mw, an objective lens is a ×50 telephoto lens, and time of exposure is 20 s. Beams are focused on a sample through the ×50 objective lens of a microscope, and enter a CCD after being split from a filter through a diffraction grating with 1800 lines per millimeter. The Raman spectrum is as shown in FIG. 2, and as the concentration decreases, the characteristic peak intensity of CV gradually decreases. When the concentration of the CV aqueous solution is as low as 10⁻¹⁰ moles per liter, the characteristic peak of CV can still be observed.

### Comparative Example 1

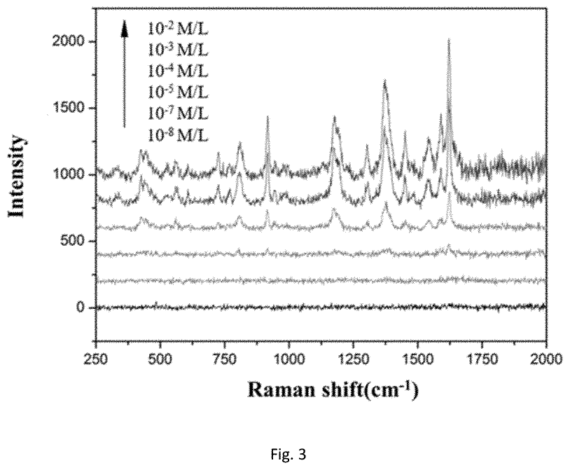

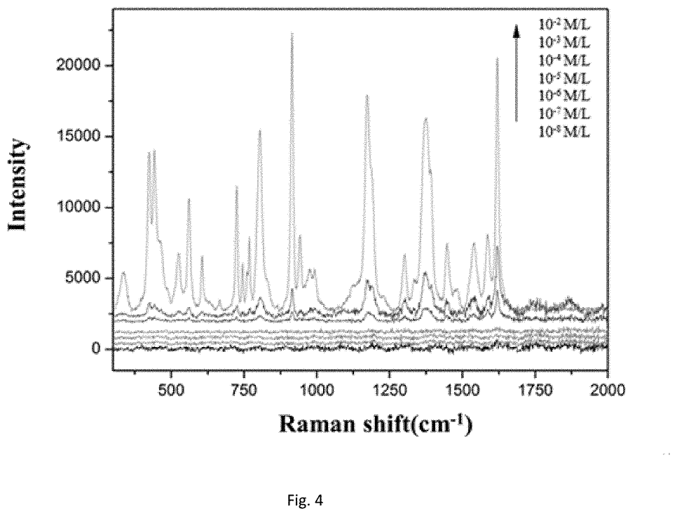

Raman testing is performed on CV aqueous solutions of different concentrations by directly using a Raman method, so a Raman spectrogram of the CV aqueous solutions of the different concentrations is obtained. A Raman spectrum is obtained by using an inVia confocal Raman spectrometer. A laser light source is 532 nm, power 12.5 mw, an objective lens is a ×50 telephoto lens, and time of exposure is 20 s. Beams are focused on a sample through the ×50 objective lens of a microscope, and enter a CCD after being split from a filter through a diffraction grating with 1800 lines per millimeter. As shown in FIG. 3, as the concentration decreases, the intensity of the characteristic peak of CV gradually decreases. When the concentration of the CV aqueous solution is as low as 10⁻⁵ moles per liter, the characteristic peak of CV is no longer obvious. It shows that a limit of detection can only reach 10⁻⁵ moles per liter when the CV aqueous solutions are tested by directly using the Raman method.

### Comparative Example 2

Raman testing is performed on CV aqueous solutions of different concentrations by using solidified polyurethane that is not soaked in a nano-silver solution. Prepared polyurethane pieces are soaked in the crystal violet aqueous solutions for several minutes. After the polyurethane are taken out, a Raman spectrum is obtained by using an inVia confocal Raman spectrometer, so as to obtain an SERS spectrogram of the polyurethane without nano-silver to the CV aqueous solutions of the different concentrations. As shown in FIG. 4, as the concentration decreases, the intensity of the characteristic peak of CV gradually decreases. Although the intensity of an SERS spectrum is higher than that of the Raman spectrum of the CV aqueous solutions when the concentration is high, when the concentration of the CV aqueous solution is as low as 10⁻⁵ moles per liter, the characteristic peak of CV is no longer obvious. It shows that a polyurethane substrate without nano silver particles does not contribute to an increase of a limit of detection of SERS.

### Comparative Example 3

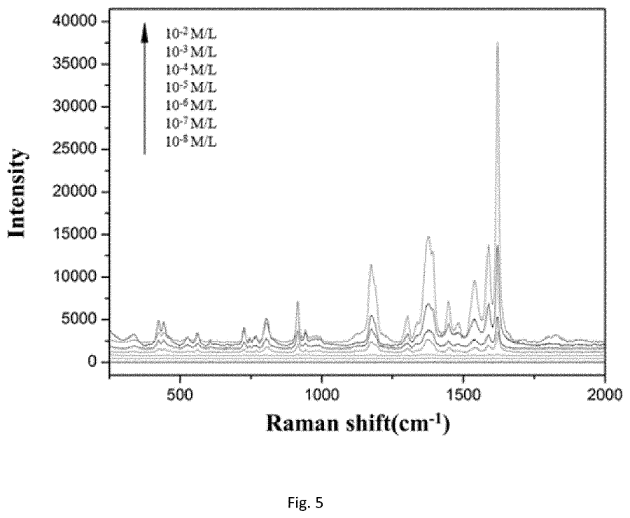

Raman testing is performed on CV aqueous solutions of different concentrations by using a nano-silver solution. The prepared nano-silver solution and the CV aqueous solutions are mixed at a volume ratio of 1:1. A Raman spectrum is obtained by using an inVia confocal Raman spectrometer, so as to obtain an SERS spectrogram of the nano-silver solution to the CV aqueous solutions of the different concentrations. As shown in FIG. 5, as the concentration decreases, the intensity of the characteristic peak of CV gradually decreases. When the concentration of the CV aqueous solution is as low as 10⁻⁶ moles per liter, the characteristic peak of CV is no longer obvious. It shows that only using the nano-silver solution as a substrate can only increase a limit of detection by one order of magnitude.

### Comparative Example 4

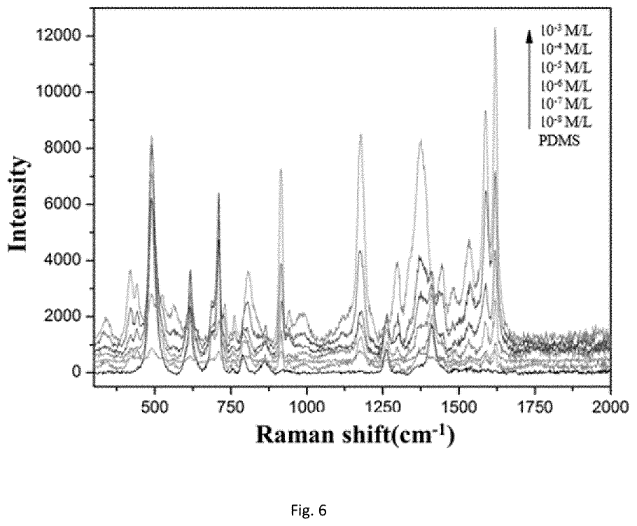

Polymer material, poly(dimethylsiloxane) (PDMS), is used to replace a polyurethane material. Solidified PDMS is soaked in a nano-silver solution for 6 h, and is soaked in crystal violet aqueous solutions of different concentrations for several minutes. A substrate is taken out, and a Raman spectrum is obtained by using an inVia confocal Raman spectrometer, so as to obtain an SERS spectrogram of the nano-silver substrate based on the polymer material PDMS to the CV aqueous solutions. As shown in FIG. 6, as the concentration decreases, the intensity of the characteristic peak of CV gradually decreases. When the concentration of the CV aqueous solution is as low as 10⁻⁶ moles per liter, the characteristic peak of CV is no longer obvious. Moreover, PDMS itself has its own characteristic peak, which will interfere with observation of the characteristic peak of the CV aqueous solution. It shows that only using PDMS instead of polyurethane as the substrate is not as effective as a polyurethane nano-silver SERS substrate.

It can be known, from the comparison of Example 1 with comparative documents 2, 3, and 4, that for the polyurethane nano-silver substrate in the present disclosure herein, when the concentration of the CV aqueous solution is as low as 10⁻¹⁰ moles per liter, the characteristic peak of CV can still be observed. It shows that an enhancement coefficient of the polyurethane nano-silver substrate to CV reaches 10⁵ or above, which is obviously superior to using only the nano-silver solution or the polyurethane, or using other polymer materials.

Although the present disclosure herein has been disclosed with preferred examples above, they are not intended to limit the present disclosure herein. Anyone familiar with this art can make various changes and modifications without departing from the spirit and scope of the present disclosure herein. Therefore, the protection scope of the present disclosure herein should be defined by the claims.

What is claimed is:

1. A preparation method of a nano-silver SERS substrate, comprising the following steps:
mixing and then evenly stirring a polyurethane A glue and a polyurethane B glue, and standing for foaming and solidification; and
chopping foamed and solidified polyurethane into pieces and soaking the pieces in a nano-silver solution to obtain the polyurethane-based nano-silver SERS substrate.

2. The preparation method according to claim 1, wherein the nano-silver solution is prepared by: reducing silver nitrate with sodium citrate to prepare the nano-silver solution; wherein a concentration of a sodium citrate solution is 0.01 g/mL, and a concentration of a silver nitrate solution is 200 mg/L.

3. The preparation method according to claim 1, wherein the polyurethane A glue and the polyurethane B glue are mixed at a mass ratio of 1:1.

4. The preparation method according to claim 1, wherein a foaming and solidification temperature is a room temperature, and foaming and solidification time is 2-6 hours.

5. The preparation method according to claim 1, wherein soaking time of the polyurethane pieces in the nano-silver solution is 6 hours or longer.

6. The preparation method according to claim 1, wherein a component of the polyurethane A glue is isocyanate, and a component of the polyurethane B glue is composite polyether.

7. The preparation method according to claim 1, further comprising the following steps:
(1) reducing silver nitrate with sodium citrate to prepare the nano-silver solution:
a. preparing a sodium citrate aqueous solution with a concentration of 0.01 g/ml and a silver nitrate aqueous solution with a concentration of 200 mg/L; and
b. taking 100 ml of the silver nitrate solution, heating to boil, quickly adding 3 ml of the sodium citrate solution dropwise, stirring while adding, and cooling to a room temperature;
(2) preparing polyurethane:
a. taking 5 g of the polyurethane A glue and 5 g of the polyurethane B glue, and stirring quickly and intensely; and
b. standing at a room temperature for 2-6 h, and chopping into pieces for later use; and
(3) preparing the polyurethane nano-silver SERS substrate:
a. soaking the chopped polyurethane pieces in the prepared nano-silver solution, so the polyurethane may adsorb nano silver particles in the solution; and
b. soaking the polyurethane pieces in the nano-silver solution for 6 hours or longer.

8. A polyurethane-based nano-silver SERS substrate prepared by the method according to claim 1.

9. A method for detecting crystal violet (CV), comprising using the polyurethane-based nano-silver SERS substrate according to claim 8.

10. The method according to claim 9, wherein the prepared polyurethane nano-silver substrate is soaked in a crystal violet aqueous solution for several minutes, a Raman spectrum is obtained by using an inVia confocal Raman spectrometer after the substrate is taken out, a laser light source is 532 nm, power is 12.5 mw, an objective lens is a ×50 telephoto lens, and time of exposure is 20 s.

11. Application of the polyurethane-based nano-silver SERS substrate according to claim 8 in the technical field of Raman spectrums.

12. Application of the polyurethane-based nano-silver SERS substrate according to claim 8 in the technical field of non-destructive testing.
